(19) United States
(12) Patent Application Publication
(10) Pub. No.: US 2008/0204489 A1
(43) Pub. Date: Aug. 28, 2008

(54) SELF-PROPELLED IMAGE TRANSLATION DEVICE

(76) Inventors: Patrick A. McKinley, Corvallis, OR (US); Gregory F. Carlson, Corvallis, OR (US)

Correspondence Address: SCHWABE, WILLIAMSON & WYATT, P.C., PACWEST CENTER, SUITE 1900, 1211 S.W. FIFTH AVENUE, PORTLAND, OR, 97204, US

(21) Appl. No.: 12/034,496

(22) Filed: Feb. 20, 2008

Related U.S. Application Data
(60) Provisional application No. 60/891,102, filed on Feb. 22, 2007.

(51) Int. Cl. B41J 29/38

(52) U.S. Cl. 347/9

(57) ABSTRACT

Systems, apparatuses, and methods for a self-propelled image translation device are described herein. The self-propelled image translation device may include a propulsion module to control propulsion components to autonomously propel the image translation device over an adjacent medium. An input/output module of the self-propelled image translation device may control input/output components to translate an image between the device and an adjacent medium. Other embodiments may be described and claimed.

### CROSS-REFERENCES TO RELATED APPLICATIONS

This present application is a non-provisional application of provisional application 60/891,102, filed on Feb. 22, 2007, and claims priority to said provisional application. The specification of said provisional application is hereby incorporated in its entirety, except for those sections, if any, that are inconsistent with this specification.

### TECHNICAL FIELD

Embodiments of the present invention relate to the field of image translation and, in particular, to a self-propelled image translation device.

### BACKGROUND

Traditional printing devices rely on a mechanically operated rail and carriage system to transport a print head in one linear direction as other mechanics advance a medium in an orthogonal direction. As the print head moves over the medium an image may be laid down.

Portable printers have been developed through technologies that reduce the size of the operating mechanics. However, the principles of providing relative movement between the print head and medium remain the same as traditional printing devices. Accordingly, these mechanics limit the reduction of size of the printer as well as the material that may be used as the medium.

Other rail and carriage systems have been developed to transport the print head in two directions across a stationary print medium. However, the dimensions of an associated rail guidance system, which are at least as large as the printed surface, also compromise the portability of the device.

Handheld printing devices have been developed that ostensibly allow an operator to manipulate a handheld device over a medium in order to print an image onto the medium. However, these devices are challenged by the unpredictable and nonlinear movement of the device by the operator. These handheld printing devices require constant operator involvement and skill in manipulating the printing device.

### SUMMARY

Some embodiments of the present invention disclose a control block of an image translation device that includes a propulsion module configured to control one or more propulsion components to autonomously propel the apparatus over a medium adjacent to the apparatus; and an input/output module configured to translate an image between the medium and the apparatus as the apparatus is propelled over the medium.

The input/output module may include a print module configured to print an image on the medium; and/or an image capture module configured to acquire an image from the medium.

The control block may also have a position module configured to determine a position of the apparatus relative to a reference location. The position module may be further configured to use one or more navigation sensors to determine the position. The position module may be coupled to the propulsion module to determine the position.

In some embodiments, the propulsion module may be further configured to propel the apparatus to an edge portion of the medium to facilitate a setting of the reference location.

A method of translating an image is also disclosed in accordance with some embodiments. The method may include controlling one or more propulsion components of an image translation device in a manner to autonomously propel the image translation device over a medium adjacent to the image translation device; and translating an image between the medium and the image translation device as the image translation device is propelled over the medium.

The method may further include initializing the image translation device prior to translating the image by setting a reference location.

The method may further include capturing one or more sensor measurements; and determining a structure and/or makeup of the medium based at least in part on the captured one or more sensor measurements.

The method may further include propelling the image translation device to a reference location; and locating the reference location based at least in part on determined structure and/or makeup of the medium.

The method may further include receiving image translation data via a wireless link.

The method may further include receiving directional and/or image translation controls via a wireless link.

In yet other embodiments, an image translation device is disclosed having one or more propulsion components; one or more input/output components; and

a control block with a propulsion module configured to control the one or more propulsion components to autonomously propel the apparatus over the medium, and an input/output module configured to control the input/output components to translate an image between the medium and the apparatus as the apparatus is propelled over the medium.

The one or more propulsion components may comprise one or more ball-drive propulsion components. Some embodiments may include two ball-drive propulsion components that extend from a surface of the device by a first distance and one or more casters configured to extend from the surface of the device by a second distance that is similar to the first distance.

The one or more contact force components may be configured to facilitate a contact force between the device and the medium.

The image translation device may include a housing to house the one or more propulsion components, the propulsion module, and the input/output module, wherein the housing is propelled over the medium.

In some embodiments and image translation system may include an image translation device having one or more propulsion components; one or more input/output components; and a control block having a propulsion module configured to control the one or more propulsion components to autonomously propel the apparatus over the medium, and an input/output module configured to control the input/output components to translate an image between the medium and the apparatus as the apparatus is propelled over the medium; and a docking station configured to removably couple to the image translation device.

The image translation device may include a power supply and the docking station may be configured to recharge the power supply when coupled to the image translation device.

The image translation device may be configured to service the one or more input/output components when coupled to the image translation device.

Other features that are considered as characteristic for embodiments of the present invention are set forth in the appended claims.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a schematic of a system including a self-propelled image translation device in accordance with various embodiments of the present invention;

FIG. 2 is a bottom plan view of a self-propelled image translation device in accordance with various embodiments of the present invention;

FIG. 3 is a graphic depiction of an image translation operation of a self-propelled image translation device in accordance with various embodiments of the present invention;

FIG. 4 is a flow diagram depicting an image translation operation of a self-propelled image translation device in accordance with various embodiments of the present invention; and

FIG. 5 schematically illustrates a computing device capable of implementing a control block of a handheld image translation device in accordance with various embodiments of the present invention.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” means that a particular feature, structure, or characteristic described in connection with the embodiment is included in at least one embodiment. The appearances of the phrase “in one embodiment” in various places in the specification do not necessarily all refer to the same embodiment, but they may.

The phrase “A/B” and “A and/or B” means (A), (B), or (A and B). The phrase “A, B, and/or C” means (A), (B), (C), (A and B), (A and C), (B and C) or (A, B and C). The phrase “(A) B” means (A B) or (B), that is, A is optional.

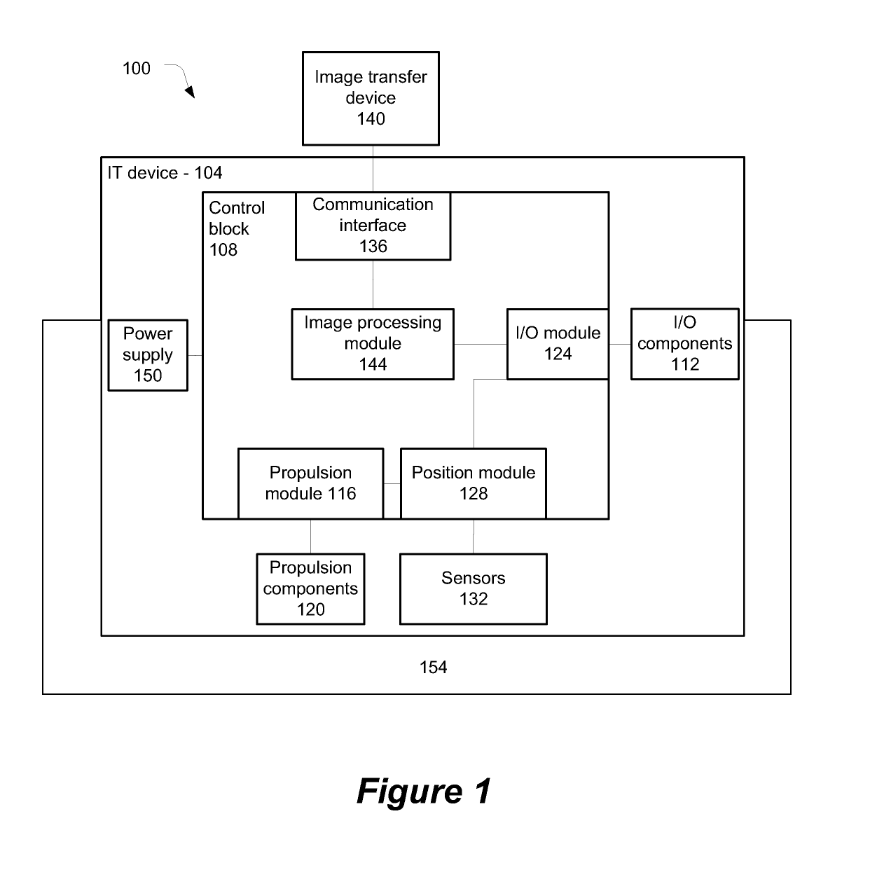

FIG. 1 is a schematic of a system 100 including a self-propelled image translation (IT) device 104, hereinafter IT device 104, in accordance with various embodiments of the present invention. The IT device 104 may include a control block 108 with components designed to facilitate controlled propulsion of the IT device 104 and accurate positioning of input/output (I/O) components 112 throughout an entire IT operation. This propulsion and positioning may allow the IT device 104 to reliably translate an image between the IT device and an adjacent medium in a truly mobile and versatile platform as will be explained herein.

Image translation, as used herein, may refer to a translation of an image that exists in a particular context (e.g., medium) into an image in another context. For example, an IT operation may be a scan operation. In this situation, a target image, e.g., an image that exists on a tangible medium, is scanned by the IT device 104 and an acquired image that corresponds to the target image is created and stored in memory of the IT device 104. For another example, an IT operation may be a print operation. In this situation, an acquired image, e.g., an image as it exists in memory of the IT device 104, may be printed onto a print medium adjacent to the IT device 104.

The IT device 104 may include a propulsion module 116 to control one or more propulsion components 120 in a manner to autonomously propel the IT device 104 over the face of an adjacent medium. As used herein, autonomously propelled may mean that the physical motion of the IT device 104 is self-supplied, e.g., done without reliance on manual intervention (e.g., hand propelled) or an external carriage support and transport system (e.g., the carriage and rail systems discussed above in the background). While the motion may be initiated by manual input and even controlled, remotely, by a person, the propulsion subsystem, e.g., the propulsion module 116 and the one or more propulsion components 120, of the IT device 104 may be capable of providing sufficient forces to move the IT device 104 across the face of the adjacent medium without any externally supplied force.

The propulsion subsystem may also have directional control so that the IT device 104 may cover the entire IT portion of the adjacent medium. The IT portion may be a subset of the adjacent medium upon which an image exists which will be acquired through a scan or the portion of the medium upon which an image may be printed. As the IT device 104 traverses the IT portion of the adjacent medium, an I/O module 124 may receive positioning information from a position module 128 and control the I/O components 112 in a manner to translate an image between the IT device 104 and the adjacent medium.

The propulsion subsystem may also have speed control. This may allow, for example, the IT device 104 to rapidly move across the adjacent medium when it is not actively engaged in image translation, and to reduce its speed to an appropriate velocity when it engages in image translation.

The position module 128 may determine positioning information of the IT device 104, and of the I/O components 112 in particular, relative to a reference location. Positioning information may include two-dimensional translation information and rotation information. The position module 128 may be coupled to the propulsion module 116 and derive the positioning information based, at least in part, on tracking the propulsion history of the IT device 104. The position module 128 may additionally/alternatively be coupled to sensors 132 to facilitate determination of positioning information.

In one embodiment, the sensors 132 may include a media sensor that may capture sensor measurements that may be used to determine a structure and/or makeup of an adjacent medium. This may allow the position module 128 to detect boundaries of an IT portion of the adjacent medium, e.g., by detecting differences in the structure and/or makeup of an adjacent medium. For example, in an embodiment a corner of a printer paper may detected and used to set a reference location that is the basis for establishing positioning information. In some embodiments, the propulsion subsystem may cooperate with the positioning subsystem, e.g., the position module 128 and the sensors 132, to locate and set this reference location by moving the IT device 104 to the corner.

In an embodiment, the sensors 132 may additionally or alternatively include one or more navigation sensors that capture navigational measurements to track incremental movement of the IT device 104 relative to the reference location. In some embodiments, the navigational measurements may be navigational images of an adjacent medium. In these embodiments, the navigation sensors may include one or more imaging navigation sensors. An imaging navigation sensor may include a light source, e.g., light-emitting diode (LED), a laser, etc., and an optoelectronic sensor designed to capture a series of navigational images of an adjacent medium as the IT device 104 is moved over the medium.

The position module 128 may process the navigational images to detect structural variations of the medium. The movement of the structural variations in successive images may indicate motion of the IT device 104 relative to the medium. Tracking this detected relative movement and/or propulsion history from the propulsion module 116 may facilitate a precise positioning of the I/O components 112.

In other embodiments, non-imaging navigation sensors, e.g., an accelerometer, a gyroscope, a pressure sensor, etc., may be additionally or alternatively used to capture navigational measurements.

Navigation sensors may have operating characteristics sufficient to track movement of the IT device 104 with the desired degree of precision. In one example, imaging navigation sensors may process approximately 2000 frames per second, with each frame including a rectangular array of 30×30 pixels. Each pixel may detect a six-bit grayscale value, e.g., capable of sensing 64 different levels of patterning.

The control block 108 may include a communication interface 136 configured to communicatively couple the control block 108 to an image transfer device 140. The image transfer device 140 may include any type of device capable of transmitting and/or receiving data related to an image, e.g., image data, involved in an IT operation. The image transfer device 140 may include a general purpose computing device, e.g., a desktop computing device, a laptop computing device, a mobile computing device, a personal digital assistant, a cellular phone, etc. or it may be a removable storage device, e.g., a flash memory data storage device, designed to store data such as image data. If the image transfer device 140 is a removable storage device, e.g., a universal serial bus (USB) storage device, the communication interface 136 may be coupled to a port, e.g., USB port, of the IT device 104 designed to receive the storage device.

The communication interface 136 may include a wireless receiver and/or transmitter to allow the communicative coupling with the image transfer device 140 to take place over a wireless link. The image data may be wirelessly transmitted over the link through the modulation of electromagnetic waves with frequencies in the radio, infrared or microwave spectrums.

A wireless link may contribute to the mobility and versatility of the IT device 104. However, some embodiments may additionally or alternatively include a wired link communicatively coupling the image transfer device 140 to the communication interface 136.

In some embodiments, the communication interface 136 may communicate with the image transfer device 140 through one or more wired and/or wireless networks including, but not limited to, personal area networks, local area networks, wide area networks, metropolitan area networks, etc. The data transmission may be done in a manner compatible with any of a number of standards and/or specifications including, but not limited to, 802.11, 802.16, Bluetooth, Global System for Mobile Communications (GSM), code-division multiple access (CDMA), Ethernet, etc.

When the IT operation includes a print operation, the communication interface 136 may receive image data from the image transfer device 140 and transmit the received image data to an onboard image processing module 144. The image processing module 144 may process the received image data in a manner to facilitate an upcoming printing process. Image processing techniques may include dithering, decompression, half-toning, color plane separation, and/or image storage. In various embodiments some or all of these image processing operations may be performed by the image transfer device 140 or another device. The processed image may then be transmitted to the I/O module 124, which may include a print module in this embodiment, where it is cached in anticipation of the print operation.

Once the I/O module 124 receives the processed image, it may then control a print head of the I/O components 112 in a manner such that a corresponding image is printed on the adjacent surface as the IT device 104 is moved over the surface and the I/O module 124 receives the positioning information from the position module 128.

The print head may be an inkjet print head having a plurality of nozzles designed to emit liquid ink droplets. The ink, which may be contained in reservoirs or cartridges, may be black and/or any of a number of various colors. A common, full-color inkjet print head may have nozzles for cyan, magenta, yellow, and black ink. Other embodiments may utilize other printing techniques, e.g., toner-based printers such as laser or LED printers, solid ink printers, dye-sublimation printers, inkless printers, etc.

In an embodiment in which an IT operation includes a scanning operation, the I/O module 124 may include an image capture module and may be communicatively coupled to one or more optical imaging sensors of the I/O components 112. Optical imaging sensors, which may include a number of individual sensor elements, may be designed to capture a plurality of surface images of an adjacent medium. The surface images may be individually referred to as component surface images. The I/O module 124 may generate a composite image by stitching together the component surface images. The I/O module 124 may receive positioning information from the position module 128 to facilitate the arrangement of the component surface images into the composite image.

In an embodiment in which the IT device 104 is capable of scanning full color images, the optical imaging sensors may have sensor elements designed to scan different colors.

Relative to the imaging navigation sensors, the optical imaging sensors may have a higher resolution, smaller pixel size, and/or higher light requirements. While the imaging navigation sensors are configured to capture details about the structure of the underlying medium, the optical imaging sensors may be configured to capture an image of the surface of the medium itself.

A composite image acquired by the IT device 104 may be subsequently transmitted to the image transfer device 140 by, e.g., e-mail, fax, file transfer protocols, etc. The composite image may be additionally/alternatively stored locally by the IT device 104 for subsequent review, transmittal, printing, etc.

In some embodiments, the acquired images (e.g., the composite image and/or component surface images) may also be used in the positioning of the IT device 104. The acquired images may be used as control feedback to adjust for accumulated positioning error. The acquired images may also be used to move the IT device to a selected area of a printed image for a specified purpose. For example, if the image on the adjacent medium is a photograph of a person, the IT device 104 may utilize the acquired images and the propulsion subsystem to move to the eye portion of the person for a red-eye reduction function.

In various embodiments, the image transfer device 140 (or another remote device) may provide various control and/or processing functionalities that is otherwise described as being a part of the IT device 104. For example, in some embodiments the image transfer device 140 may communicate directional and/or IT controls remotely. One embodiment utilizing remote directional and/or IT controls may provide that the image transfer device 140 is a tablet personal computer (PC). A user may use a writing instrument to write on the tablet PC. These motions may be the basis for controlling the IT device 104 to print a corresponding image on an adjacent medium. Other remote control applications may be within the realm of embodiments of the present invention.

The IT device 104 may include a power supply 150 coupled to the control block 108. The power supply 150 may be a mobile power supply, e.g., a battery, a rechargeable battery, a solar power source, etc. In other embodiments the power supply 150 may additionally or alternatively regulate power provided by another component (e.g., the image transfer device 140, a power cord coupled to an alternating current (AC) outlet, etc.).

The system 100 may also have a docking station 154 to receive the IT device 104 in a removably coupled relationship when the IT device 104 is not in use. The docking station 154 may be used to service the print heads of the I/O components 112 (e.g., clean and cap for storage), recharge the power supply 150, and to protect the IT device 104.

In some embodiments, the docking station 154 may be coupled to the image transfer device 140 to receive IT data and communicate the IT data to the IT device 104 when connected.

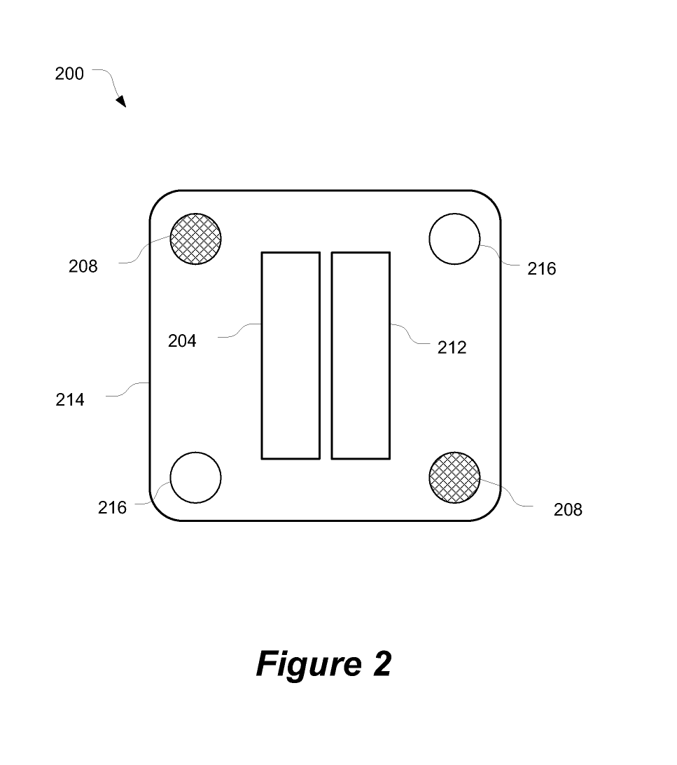

FIG. 2 is a bottom plan view of an IT device 200 in accordance with various embodiments of the present invention. The IT device 200 may have I/O components 204, propulsion components 208, and/or sensors 212 housed by a housing 214. The IT device 200 may be similar to IT device 104 with like-named elements being substantially interchangeable.

The propulsion components 208 may each be omnidirectional ball-drive propulsion components (hereinafter “ball drives”) configured to propel the IT device 200 over the adjacent medium in a controllable manner. A ball drive may include a ball that extends from the bottom surface of the IT device 200 to contact an adjacent surface. The ball may be a rubber, rubberized, or rubber-like ball designed to provide sufficient traction with the adjacent medium to propel the IT device. Sufficient traction may be facilitated through a contact force between the IT device 200 and the adjacent medium.

A contact force may include a gravitational component provided by the weight of the IT device 200 when the medium is in a horizontal plane. Other embodiments may supplant or augment a gravitational component of contact force with other attractive forces. For example, a contact force may be provided, at least in part, by providing a low-pressure field. This may be done using a vacuum-type arrangement. In another example, a contact force may be provided, at least in part, by an attractive intermolecular force, which may also be referred to as van der Waals force. A sufficient attractive intermolecular force may be provided by covering the contact surface of the ball (or other component of the IT device 200) with synthetic setae that provide a large area of contact, thereby increasing the attractive intermolecular force. The synthetic setae may be constructed of an elastomer. In yet another example, the contact force may include a magnetic component, with the ball and the adjacent surface (or substrate of the surface) constructed of materials having complementary magnetic properties. Embodiments having the gravitational component of the contact force supplanted and/or augmented by other force components may allow the IT device 200 to print on sloped surfaces, vertical surfaces, or even upside-down.

The contact force may be provided by one or more contact force components, which may be a part of, or separate from, the propulsion components 208.

The IT device 200 may also have rolling support members 216, e.g., casters, configured to provide stable platform motion. The rolling support members 216 and the propulsion components 208 may extend from the bottom surface of the IT device 200 by a similar amount so that the bottom surface is substantially parallel to the adjacent medium.

The IT device 200 may include more or less components than shown in FIG. 2. Furthermore, the components may be arranged in any of a number of configurations.

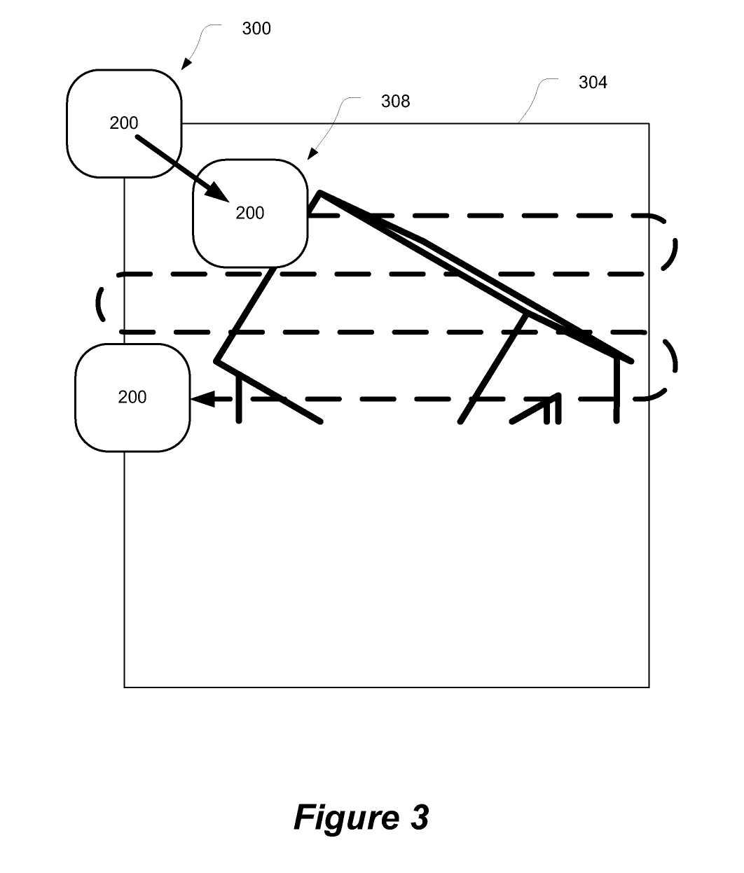

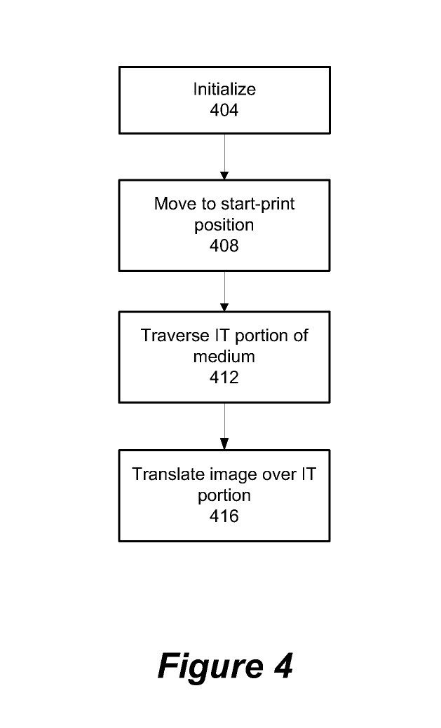

FIGS. 3 and 4 are a graphic depiction of an IT operation of the IT device 200 and an accompanying flow diagram, respectively, in accordance with an embodiment of the present invention. At block 404, the IT device 200 may move to an initialization position 300 and initialize by setting a reference location. In this embodiment, the starting position may be the top, left-hand corner of a print medium 304. In other embodiments, the IT device 200 may not move to a starting position and may initialize at the receipt of an appropriate command.

At block 408, the IT device 200 may then move to a start-print position 308, which places the IT device 200 at a beginning of a printing portion of a first print pass.

At block 412, the IT device 200 may proceed to sequentially traverse an IT portion of the print medium 304. As the IT device 200 traverses the IT portion the position subsystem may update the positioning information based on data provided from sensors 212 and/or the propulsion subsystem.

At block 416, the IT device 200 may translate an image as it traverses the IT portion. As discussed above, an I/O subsystem may translate an image based at least in part on the positioning information provided by the positioning subsystem as the IT device 200 traverses the IT portion.

While FIG. 3 illustrates the traversal path of the IT device 200 as being a serpentine path over the print medium 304, other embodiments may include other traversal patterns. In some embodiments, the traversal pattern may be based at least in part on what portions of the image have yet to be printed. Accordingly, if a section of the print medium 304 does not host a portion of the printed image, it need not be traversed.

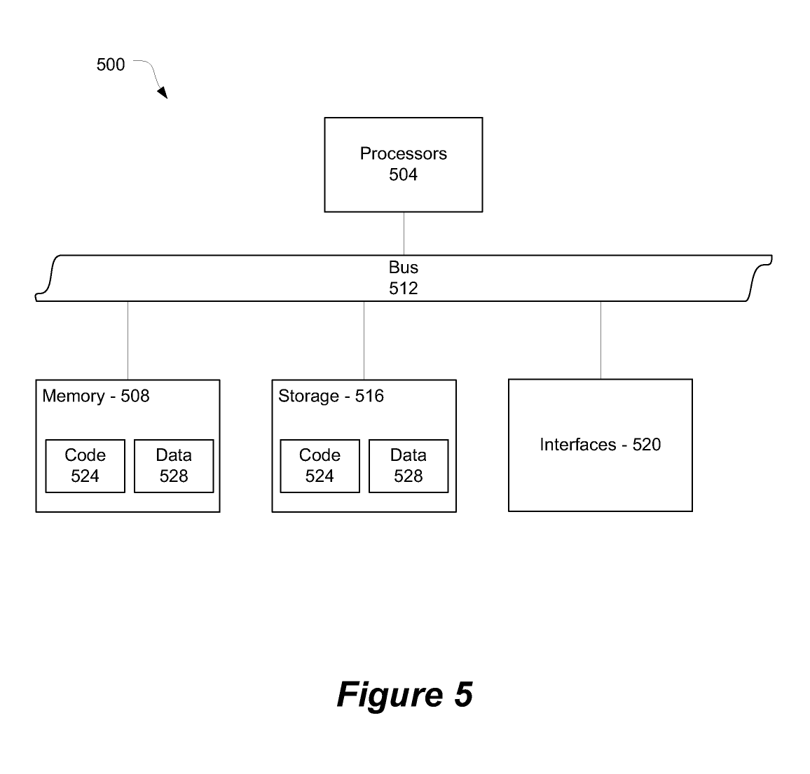

FIG. 5 schematically illustrates a computing device 500 capable of implementing a control block, e.g., control block 108, in accordance with various embodiments. As illustrated, for the embodiments, computing device 500 includes one or more processors 504, memory 508, and bus 512, coupled to each other as shown. Additionally, computing device 500 includes storage 516, and one or more interfaces 520 coupled to each other, and the earlier described elements as shown. The components of the computing device 500 may be designed to provide the propulsion and/or IT functions of a control block of an IT device as described herein.

Memory 508 and storage 516 may include, in particular, temporal and persistent copies of code 524 and data 528, respectively. The code 524 may include instructions that when accessed by the processors 504 result in the computing device 500 performing operations as described in conjunction with various modules of the control block in accordance with embodiments of this invention. The data 528 may include data to be acted upon by the instructions of the code 524. In particular, the accessing of the code 524 and data 528 by the processors 504 may facilitate propulsion and/or IT operations as described herein.

The processors 504 may include one or more single-core processors, multiple-core processors, controllers, application-specific integrated circuits (ASICs), etc.

The memory 508 may include random access memory (RAM), dynamic RAM (DRAM), static RAM (SRAM), synchronous DRAM (SDRAM), dual-data rate RAM (DDRRAM), etc.

The storage 516 may include integrated and/or peripheral storage devices, such as, but not limited to, disks and associated drives (e.g., magnetic, optical), USB storage devices and associated ports, flash memory, read-only memory (ROM), non-volatile semiconductor devices, etc. Storage 516 may be a storage resource physically part of the computing device 500 or it may be accessible by, but not necessarily a part of, the computing device 500. For example, the storage 516 may be accessed by the computing device 500 over a network.

The interfaces 520 may include interfaces designed to communicate with peripheral hardware, e.g., I/O components 112, sensors 132, etc., and/or remote devices, e.g., image transfer device 140.

In various embodiments, computing device 500 may have more or less elements and/or different architectures.

Although specific embodiments have been illustrated and described herein, it will be appreciated by those of ordinary skill in the art and others, that a wide variety of alternate and/or equivalent implementations may be substituted for the specific embodiment shown and described without departing from the scope of the present invention. This application is intended to cover any adaptations or variations of the embodiment discussed herein. Therefore, it is manifested and intended that the invention be limited only by the claims and the equivalents thereof.

What is claimed is:

1. An apparatus comprising:
a propulsion module configured to control one or more propulsion components to autonomously propel the apparatus over a medium adjacent to the apparatus; and
an input/output module configured to translate an image between the medium and the apparatus as the apparatus is propelled over the medium.

2. The apparatus of claim 1, wherein the input/output module includes a print module configured to print an image on the medium.

3. The apparatus of claim 1, wherein the input/output module includes an image capture module configured to acquire an image from the medium.

4. The apparatus of claim 3, wherein the input/output module further includes a print module configured to print an image on the medium.

5. The apparatus of claim 1, further comprising:
a position module configured to determine a position of the apparatus relative to a reference location.

6. The apparatus of claim 5, wherein the position module is further configured to use one or more navigation sensors to determine the position.

7. The apparatus of claim 5, wherein the position module is coupled to the propulsion module.

8. The apparatus of claim 5, wherein the propulsion module is further configured to propel the apparatus to an edge portion of the medium to facilitate a setting of the reference location.

9. A method comprising:
controlling one or more propulsion components of an image translation device in a manner to autonomously propel the image translation device over a medium adjacent to the image translation device; and
translating an image between the medium and the image translation device as the image translation device is propelled over the medium.

10. The method of claim 9, further comprising:
setting a reference location.

11. The method of claim 9, further comprising:
capturing one or more sensor measurements; and
determining a structure and/or makeup of the medium based at least in part on the captured one or more sensor measurements.

12. The method of claim 11, further comprising:
propelling the image translation device to a reference location; and
locating the reference location based at least in part on determined structure and/or makeup of the medium.

13. The method of claim 9, further comprising:
receiving image translation data via a wireless link.

14. The method of claim 9, further comprising:
receiving directional and/or image translation controls via a wireless link.

15. An apparatus comprising:
one or more propulsion components;
one or more input/output components; and
a control block having
a propulsion module configured to control the one or more propulsion components to autonomously propel the apparatus over the medium, and
an input/output module configured to control the input/output components to translate an image between the medium and the apparatus as the apparatus is propelled over the medium.

16. The apparatus of claim 15, wherein the one or more propulsion components comprise one or more ball-drive propulsion components.

17. The apparatus of claim 16, wherein the one or more ball-drive propulsion components comprise two ball-drive propulsion components that extend from a surface of the apparatus by a first distance and the apparatus further comprises:
one or more casters configured to extend from the surface of the apparatus by a second distance that is similar to the first distance.

18. The apparatus of claim 15, further comprising:
one or more contact force components configured to facilitate a contact force between the apparatus and the medium.

19. The apparatus of claim 15, further comprising:
a housing to house the one or more propulsion components, the propulsion module, and the input/output module, wherein the housing is propelled over the medium.

20. A system comprising:
an image translation device having
one or more propulsion components;
one or more input/output components; and
a control block having
a propulsion module configured to control the one or more propulsion components to autonomously propel the apparatus over the medium, and
an input/output module configured to control the input/output components to translate an image between the medium and the apparatus as the apparatus is propelled over the medium; and
a docking station configured to removably couple to the image translation device.

21. The system of claim 20, wherein the image translation device includes a power supply and the docking station is configured to recharge the power supply when coupled to the image translation device.

22. The system of claim 20, wherein the docking station is configured to service the one or more input/output components when coupled to the image translation device.
